(19) United States
(12) Patent Application Publication
(10) Pub. No.: US 2006/0149923 A1
(43) Pub. Date: Jul. 6, 2006

(54) Microprocessor optimized for algorithmic processing

(75) Inventor: Paul Goodwin, Austin, TX (US)

Correspondence Address: J. SCOTT DENKO, ANDREWS & KURTH LLP, 111 CONGRESS AVE., SUITE 1700, AUSTIN, TX, 78701, US

(73) Assignee: Staktek Group L.P.

(21) Appl. No.: 11/007,745

(22) Filed: Dec. 8, 2004

(51) Int. Cl. G06F 15/00

(52) U.S. Cl. 712/11

(57) ABSTRACT

Provided is a microprocessor optimized for algorithmic processing for accelerating algorithm processing through a closely coupled set of parallel sub-processing elements. The device includes a primary processor, one or more subprocessors and an interconnecting buss. The buss is preferably a crossbar buss. The primary processor is preferably a pipelined CPU with additional logic to support algorithm processing. The crossbar buss allows the data memory to function as the data memory in the CPU, and provides paths to configure and initialize the algorithm subprocessors and to retrieve results from the subprocessors. The subprocessors are processing elements that execute segments of code on blocks of data. Preferably, the subprocessors are reconfigurable to optimize performance for the algorithm being executed.

### TECHNICAL FIELD

The present invention relates, in general, to microprocessors and, more particularly, to a processor architecture employing a closely coupled set of parallel sub-processing elements that is capable of parallel processing routines for increasing the performance of microprocessor systems for algorithmic processing.

### BACKGROUND OF THE INVENTION

Algorithm processing has been in use for years. Typically, processing units for algorithm processing are comprised of conventional general-purpose microprocessors. However, conventional general-purpose microprocessors are optimized for general purpose computing. Such microprocessors are designed to be used in a wide range of applications. Consequently, they contain instructions and logic to support all possible applications, the burden of which may sacrifice performance. Many instructions are unnecessary for a large subset of the tasks. The decode logic for such unnecessary instructions occupies area on the silicon die and such unnecessary logic generates heat that must be dissipated. In some cases, unnecessary logic may become a limiting factor of microprocessor speed.

A typical conventional algorithm processor also contains a fixed instruction set that may not be tailored for the particular algorithm in operation. Consequently, ultimate performance may be compromised.

A variety of methods are known in the art to ameliorate some of shortcomings of the general-purpose microprocessor. Such methods include parallel processing and grid computing. While significant performance improvements may be achieved, they are typically not without significant costs. Traditional parallel processing requires, for example, a system comprised of multiple instances of a processor and associated support logic. It can be appreciated that multiple instances of an inefficient processing unit results in increased operating costs.

Grid computing attempts to alleviate inefficiencies by distributing the workload to existing processors to be executed on what would otherwise be idle processing cycles. This may compromise the security and integrity of the data. When the processing of an algorithm (work units) is distributed, other programs running on the remote machine may compromise the results, or the results may not be returned due to an interruption in the interconnecting network or a power failure to that machine. Grid computing may also generate invalid results. This can arise from processing operations on machines that may have been overclocked. Further, grid computing typically exhibits high inter-processor data transmission times.

Other schemes connect together special purpose processors on a PCI (Peripheral Component Interconnect) or similar external shared data buss. On a shared buss architecture, however, the processor or controller may have to wait for access to the shared buss, which tends to slow algorithm processing. Further, for certain types of communications intensive algorithms, a typical shared buss may not provide the needed capacity to communicate between the various system processors. Such performance problems are compounded on parallel computing systems having multiple processors connected over Ethernet or other networking schemes. Further, multiple processors, peripheral components, and buss traces consume large amounts of space on circuit boards.

While the typical solutions described above may be suitable in some applications, they are not as suitable for accelerating algorithm processing through a closely coupled set of parallel sub-processing elements in a space-constrained environment. What is needed, therefore, are methods and structures that tend to accelerate algorithm processing through a closely coupled set of parallel sub-processing elements.

### SUMMARY

A new algorithmic processing microprocessor architecture and system are provided. Preferred embodiments include a primary processing unit, one or more sub-processing units, an interconnecting network, a system interface buss, and a memory buss. Preferably, the primary processor is a pipelined CPU with additional elements to support algorithm processing. Additional preferred elements are comprised of an interconnection network and a set of control registers and status registers. The subprocessors are processing elements that execute segments of code on blocks of data. These processing elements are re-configurable to optimize the sub-processor for the algorithm being executed.

In a preferred embodiment, the interconnection network is a crossbar buss or switch. A preferred interconnection network provides the primary processor access to the data memory associated with the primary processor as well as paths to configure and initialize subprocessors and retrieve results as well as an expansion port to an off-chip processing element. The interconnection network connects the primary processor to its data memory cache as well as to the data and instruction memory of the subprocessors.

### BRIEF DESCRIPTION OF THE DRAWINGS

FIG. 1 depicts an exemplary algorithm processor system according to one embodiment of the present invention.

FIG. 2 depicts a block diagram of a processor employed in a preferred embodiment of the present invention.

FIG. 3 depicts a detailed block diagram of a primary processor unit according to another embodiment of the present invention.

FIG. 4 depicts a detailed block diagram of a sub-processor according to one embodiment of the present invention.

FIG. 5 depicts a detailed block diagram of an interconnection network according to one embodiment of the present invention.

FIG. 6 shows a set of registers according to one preferred embodiment of the present invention.

FIG. 7 depicts a flow chart of one preferred sequence of operation for a subprocessor according to one embodiment of the present invention.

FIG. 8 depicts an alternative embodiment of a processor according to an alternative embodiment of the present invention.

FIG. 9 depicts a sequence of operation according to one embodiment of the present invention.

FIG. 10 depicts one alternative sequence of operation according to one embodiment of the present invention.

FIG. 11 is an elevation view of an example module that may be employed in accordance with one preferred embodiment of the present invention.

### DETAILED DESCRIPTION OF PREFERRED EMBODIMENTS

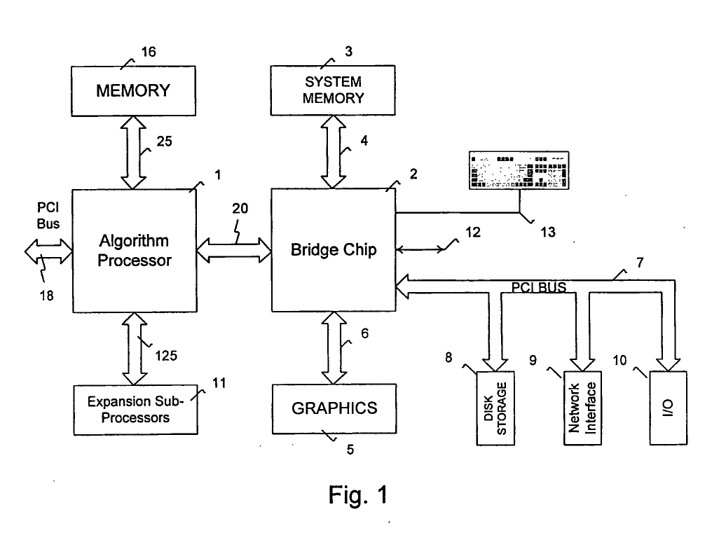

FIG. 1 depicts an exemplary algorithm processor system that includes a processor 1 according to one embodiment of the present invention. Processor 1 is preferably embodied in a single integrated circuit. Such a circuit may be packaged separately or may be combined with other integrated circuits in a multi-chip module or other high density module. In the depicted embodiment, processor 101 interfaces to a local memory 16 over an external memory interface 25. External memory interface 25 preferably employs a fast SDRAM or other type protocol. Processor 1 also interfaces with an expansion processor 11 through an external processor interface 125 and to a bridge chipset 2 over a front side buss 20. In the depicted embodiments, processor 1 has a PCI interface 18 for alternate applications.

In this embodiment, bridge 2 bridges processor 1 to a system memory 3, which preferably employs a fast SDRAM or other type protocol, and may provide data compression/decompression to reduce buss traffic over the system memory buss 4. The integrated graphics unit 5 provides TFT, DSTN, RGB or other type of video output. Bridge 2 further connects processor 1 to a conventional peripheral buss 7 (e.g., PCI), connecting to peripherals such as I/O 10, network controller 9, disk storage 8 as well as a fast serial link 12, which in some embodiments may be IEEE 1394 “firewire” buss and/or universal serial buss “USB”, and a relatively slow I/O port 13 for peripherals such as keyboard and mouse. Alternatively, bridge 2 may integrate local buss functions such as sound, disk drive control, modem, network adapter, etc. Alternatively, processor 1 may integrate chipset functions such as graphics and I/O busses and local buss functions such as disk drive control, modem, network adapter, etc.

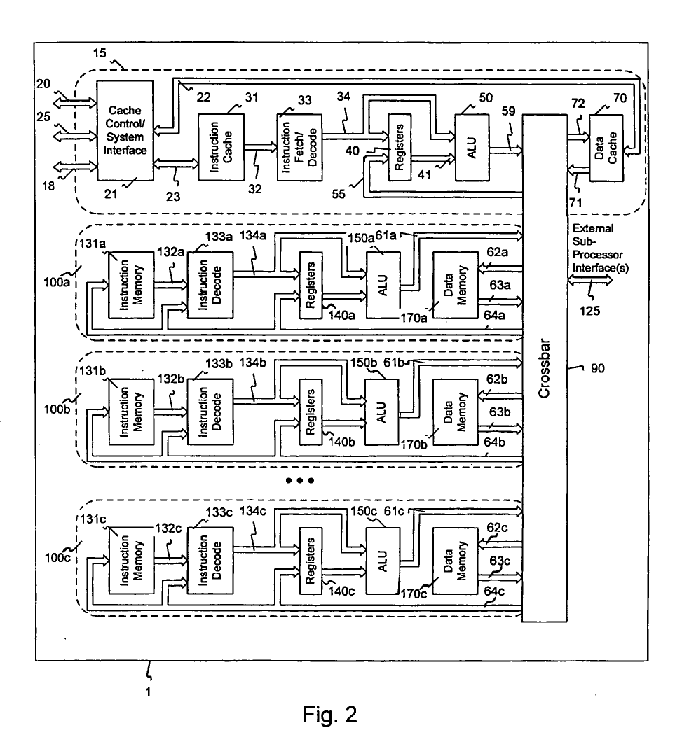

FIG. 2 depicts a block diagram of a micro-multi-processor 1 according to one embodiment of the present invention. In the interest of clarity, FIG. 2 only shows those portions of processor 1 that are relevant to an understanding of an embodiment of the present invention. Details of general construction are well known by those of skill in the art. For example, D. Patterson and J. Hennessy, Computer Organization and Design, describes many common processor architecture and design methods. The features shown in FIG. 2 will be described in more detail with reference to later Figures.

Processor 1 is, in this embodiment, constructed on a single IC. Such construction tends to reduce the number of input/output pins and time delay associated with signaling in multi-processor systems with more than one processor IC.

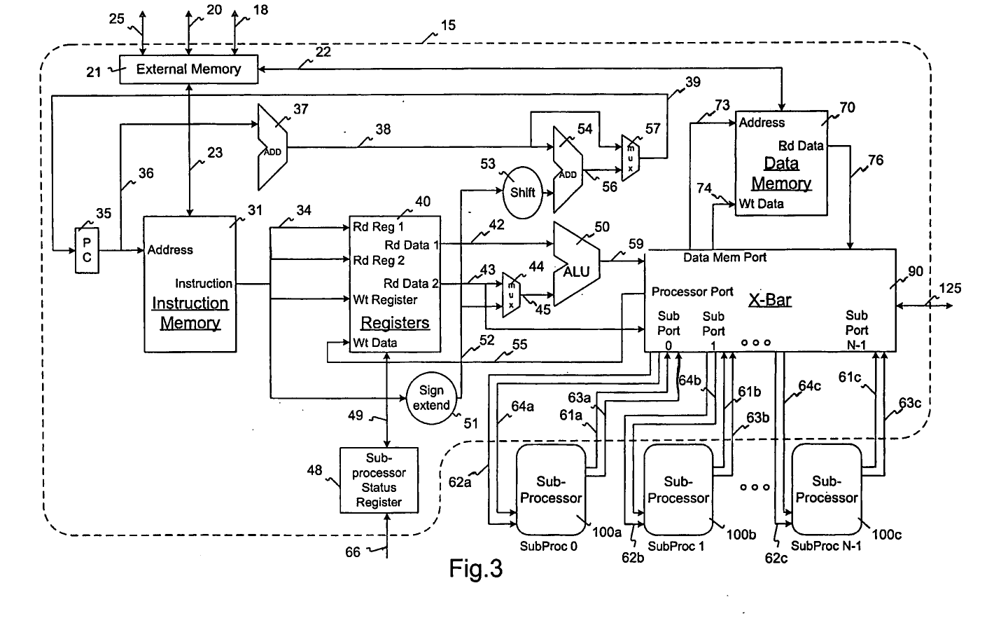

FIG. 3 depicts a detailed block diagram of a primary processor unit 15 according to another embodiment of the present invention. Referring now to FIG. 2 and FIG. 3, in processor 1 there are shown a primary processing unit (PPU) 15, a plurality of sub-processor units (SPU) 100, and an interconnecting network 90. PPU 15 further has a cache control/system interface 21, a local memory interface 25, a general purpose I/O buss 18, an instruction cache 31, an instruction fetch/decode 33, a shared multiport register file 40 (“register file”, “registers”) from which data are read and to which data are written, a command and status register file 48 from which the SPU 100 are controlled and status read, an arithmetic logic unit (“ALU”) 50, and a data cache 70 (“data cache”, “data memory”).

In the primary processor 15 instructions are fetched by instruction fetch/decode 33 from instruction memory 31 over a set of busses 32. Decoded instructions are provided from the instruction fetch/decode unit 33 to registers 40 and ALU 50 over various sets of control lines. Data are provided to/from register file 40 from/to ALU 50 over a set of busses 41 (FIG. 2). Busses 41 are depicted in more detail in FIG. 3 to include busses 42, 43, and 45. Buss 45 further connects registers 40 to interconnection network 90. Data are provided to/from memory 70 from/to ALU 50 and register file 40 via a set of busses 22, 55, and 59 through interconnection network 90 via a second set of busses 71 and 72 (FIG. 2). In the embodiment shown in FIG. 3, such interconnecting busses are shown with more detail including address buss 73, write data buss 74, and read data buss 76.

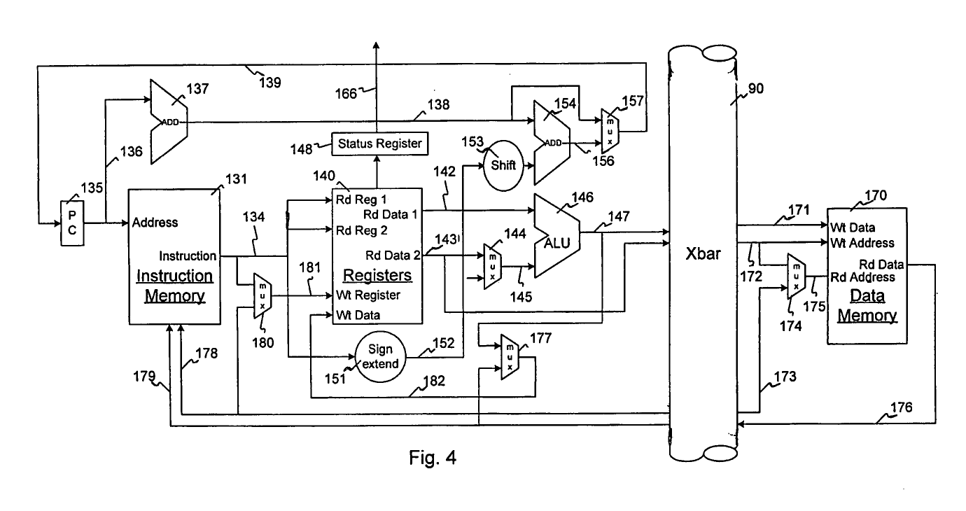

FIG. 4 depicts a detailed block diagram of a sub-processor 100 according to one embodiment of the present invention. Sub-processor 100 is comprised of: an instruction memory 131, a shared multiport register file 140 from which data are read and to which data are written, an arithmetic logic unit (“ALU”) 146, and a data memory 170. In the sub-processor 100 instructions are fetched by instruction fetch/decode 133 from instruction memory 131 over a set of busses 132 (FIG. 2). Decoded instructions are provided from the instruction fetch/decode unit 133 to the functional units 140, 146, and 154 over sets of control lines 152 and 145 (FIG. 4). Data are provided from the register file 140 to ALU 146 over a set of busses 142, and 143. Data are provided from the data memory 170 to the register file 140 via a set of busses 143, 147, and 155 through the interconnection network 90 via a second set of busses 171, 172, 173, and 176.

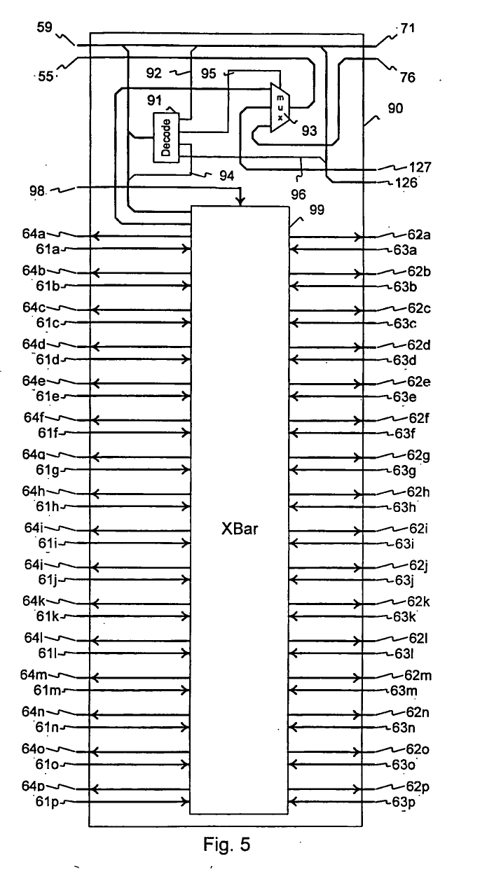

FIG. 5 depicts a detailed block diagram of an interconnection network 90 according to one embodiment of the present invention. Interconnection network 90 is comprised of: a set of busses dedicated to the primary processor 55, 59, 71, and 76, a set of busses to support the number of instances of a sub-processor 61a-p, 62a-p, 63a-p, and 64a-p, a set of busses for the expansion processor 126 and 127, a crossbar configuration buss 98, an address decoder 91, a read data mux 93, and a crossbar switch 99 (“crossbar switch”, “crossbar”, “Xbar”), which has sufficient ports to support the primary processor 15 and the instantiated sub-processor units 100. The address field of buss 59 presents addresses from the primary processor targeting the data in the primary data memory 70, a sub-processor data memory 179, or the external processor. The address is decoded by address decoder 91 which generates a data memory enable 92, a sub-processor enable 94, or an expansion processor enable 96. The enables are forwarded to the associated port with the address, data and write enable from buss 59. Read data returning from the data memory 70 on buss 76, expansion processor port 127 and the Xbar 99 on buss 97 are selected by the read data mux 93 by the read address on buss 59.

In this embodiment, crossbar 99 is configured via the configuration buss 98, which preferably connects to registers 40 and/or ALU 50. Crossbar 99 connects the processing elements of the subprocessors 100a-p with a data memory 179a-p by connecting buss 61 of the sub-processor 100a-p with the buss 62 of the data memory 170a-p and by connecting the buss 63 of the data memory 170a-p with buss 64 of sub-processor 100a-p. The selection of the sub-processor 100a-p to be connected to a data memory 170 is a result of a value written into the data memory control register 208 associated with the data memory 170a-p. Crossbar 90 may also be configured to connect the primary processor 15 with one or more data memories 170a-p by connecting buss 59 with one or more of the busses 62a-p or one or more subprocessors 100a-p by connecting buss 59 with one or more of the busses 64a-p.

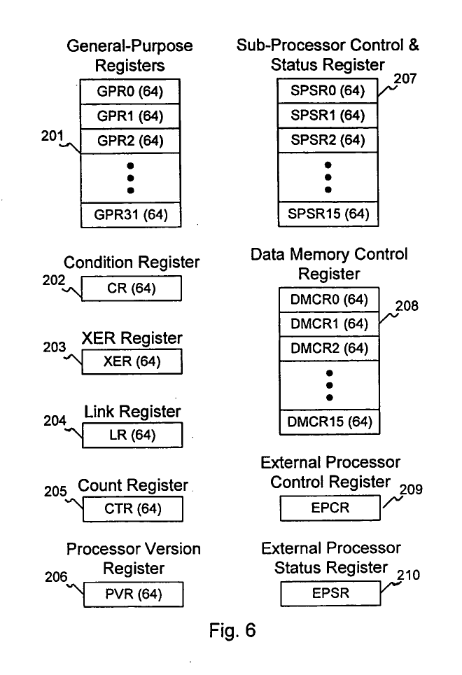

FIG. 6 shows a set of registers according to one preferred embodiment of the present invention. In this embodiment, the sub-processor registers 48 in the primary processor 15 has a set of registers 207-210 in addition to the general-purpose registers 201-206 that are used to configure the interconnection network 90, control the subprocessors 100 and check sub-processor status. There is a control register 208 for each sub-processor data memory 170 that has fields to control which processor (15 or 100a-p) is coupled to it through the interconnection network 90. There is a control and status register 207 for each sub-processor 100a-p that the primary processor 15 uses to enable configuration, control execution and check status. There is set of control and status registers 209-210 for the external processor that is used by the primary processor 15 to enable configuration, control execution and check status.

In this embodiment, the data memory control register 208 has two fields to enable the data memory 170 and to select the processor 15, 100a-p that is coupled to the data memory 170 through the interconnection network 90. There is a register 208 for each of the sub-processor data memories 170a-p. The bits in the data memory control registers 208 are preferably assigned as listed in Table 1.

TABLE 1
Data memory control register.

| Field | Size | Extent | Access | Default | Function |
|---|---|---|---|---|---|
| Src | 5 | [4:0] | RdWrInit | 1′b0 | Source |
| Reserved | 3 | [7:5] | zero | 1′b0 | Reserved |
| Enb | 1 | [8] | RdWrInit | 1′b0 | Data Memory Enable |
| Reserved | 55 | [63:9] | zero | 1′b0 | Reserved |

The enable bit is used to put the memory in an active state or a reduced power state to reduce the power consumption of the algorithm processor 1 when the data memory 170 is not in use. The default state of the enable bit is a zero (0). Setting the bit to a one (1) enables the memory.

In this embodiment the source field of the data memory control register 208 selects which processor 15,100a-p the data memory 170 is coupled with through the interconnection network 90. The value written to the source field is sent over a set of wires that are concatenated with the sets of wires from the other data memory control registers to form the crossbar control buss 98. The values passed configure the crossbar to connect the write path 62a-p and read path 63-A-a of the data memory 170 with the write path 61 a-p and read path 64a-p of the selected processor 15,100a-p. The processor coupled with the data memory for a particular value in the source field in the preferred embodiment is listed in Table 2.

TABLE 2
Source field.

| [4] | [3] | [2] | [1] | [0] | Source | Comments |
|---|---|---|---|---|---|---|
| 0 | X | X | X | X | PP | Primary Processor |
| 1 | 0 | 0 | 0 | 0 | SP0 | Sub-processor 0 |
| 1 | 0 | 0 | 0 | 1 | SP1 | Sub-processor 0 |
| 1 | 0 | 0 | 1 | 0 | SP2 | Sub-processor 2 |
| 1 | 0 | 0 | 1 | 1 | SP3 | Sub-processor 3 |
| 1 | 0 | 1 | 0 | 0 | SP4 | Sub-processor 4 |
| 1 | 0 | 1 | 0 | 1 | SP5 | Sub-processor 5 |
| 1 | 0 | 1 | 1 | 0 | SP6 | Sub-processor 6 |
| 1 | 0 | 1 | 1 | 1 | SP7 | Sub-processor 7 |
| 1 | 1 | 0 | 0 | 0 | SP8 | Sub-processor 8 |
| 1 | 1 | 0 | 0 | 1 | SP9 | Sub-processor 9 |
| 1 | 1 | 0 | 1 | 0 | SP10 | Sub-processor 10 |
| 1 | 1 | 0 | 1 | 1 | SP11 | Sub-processor 11 |
| 1 | 1 | 1 | 0 | 0 | SP12 | Sub-processor 12 |
| 1 | 1 | 1 | 0 | 1 | SP13 | Sub-processor 13 |
| 1 | 1 | 1 | 1 | 0 | SP14 | Sub-processor 14 |
| 1 | 1 | 1 | 1 | 1 | SP15 | Sub-processor 15 |

In this embodiment, the Sub-processor control and Status register 207 has three (3) fields to control the execution and to read the status of the subprocessors 100. There is a register 207 for each of the subprocessors 100a-p. Preferably, the bits in the Sub-processor control and Status registers 207 are assigned as shown in Table 3.

TABLE 3
Sub-processor control and status registers.

| Field | Size | Extent | Access | Default | Function |
|---|---|---|---|---|---|
| Command | 3 | [2:0] | RdWrInit | 1′b0 | command |
| Reserved | 1 | [3] | Zero | 1′b0 | Reserved |
| Status | 3 | [6:4] | RdWrInit | 1′b0 | Status |
| Reserved | 57 | [63:7] | Zero | 1′b0 | Reserved |

The primary processor 15 uses the command field to enable configuration and control the execution of the sub-processor. The Commands and the values for the preferred embodiment are given in Table 4.

TABLE 4
Command field.

| [2] | [1] | [0] | Mode | Comments |
|---|---|---|---|---|
| 0 | 0 | 0 | Power-Down | |
| 0 | 0 | 1 | Reset | |
| 0 | 1 | 0 | Hold | |
| 0 | 1 | 1 | Run | |
| 1 | 0 | 0 | Config | Instruction Memory |
| 1 | 0 | 1 | Config | Registers |
| 1 | 1 | 0 | Config | Instruction Set |
| 1 | 1 | 1 | Reserved | |

The POWER-DOWN command puts the sub-processor 100 in a reduced power state to reduce power consumption in the algorithm processor 15 when the sub-processor resource is not in use. The RESET command is used to clear the status of the previous execution and to return from an exception state. The HOLD command causes the sub-processor to pause execution and the RUN command starts execution of the program in the instruction memory or restarts execution after a HOLD command.

In this embodiment, the processor states of the subprocessors 100 are accessible to the primary processor 15 in the status field of the sub-processor status and command registers 207. The preferred set of states the subprocessors status are given in Table 5.

TABLE 5
Sub-processor states.

| [2] | [1] | [0] | Mode | Comments |
|---|---|---|---|---|
| 0 | 0 | 0 | Power-Down | |
| 0 | 0 | 1 | Un-Initialized | |
| 0 | 1 | 0 | Reserved | |
| 0 | 1 | 1 | Error | |
| 1 | 0 | 0 | Idle | |
| 1 | 0 | 1 | Paused | |
| 1 | 1 | 0 | Busy | |
| 1 | 1 | 1 | Done | |

The Power-DOWN state indicates that the sub-processor 100 is in a powered down state, Un-initialized indicates that the sub-processor 100 has been powered on but has not been initialized, Error indicates an exception has occurred during execution, Paused indicates the HOLD command has paused execution, Busy indicates that the sub-processor 100 is executing the code sequence in it's instruction memory and DONE indicates that the sub-processor has completed executing the code sequence and is waiting for servicing by the primary processor 15.

The External Processor control register 209 is used to control the external processors. The bits and the values for the bits in control register are external processor specific and as such there are no specific field or bit assignments.

The External Processor control register 210 is used to read the status in the external processors. The bits and the values for the bits in control register are external processor specific and as such there are no specific field or bit assignments.

The External sub-processor interface 125 is a port on the interconnecting network 90 that connects to a set of pins on the device that provides access to external subprocessors, co-processors or re-configurable logic elements. This port is used to connect additional sub-processing elements to the primary processor 15.

In operation of one embodiment, the primary processor 15 operates as a fully functional processor with additional registers to control subprocessors 100. When the primary processor 15 is reset all of the registers, cache flags and the program counter are initialized to their default value. The default state of the registers controlling the subprocessors puts the subprocessors into a power-down state. The primary processor 15 enables and configures the subprocessors 100 according to instructions in the executable code.

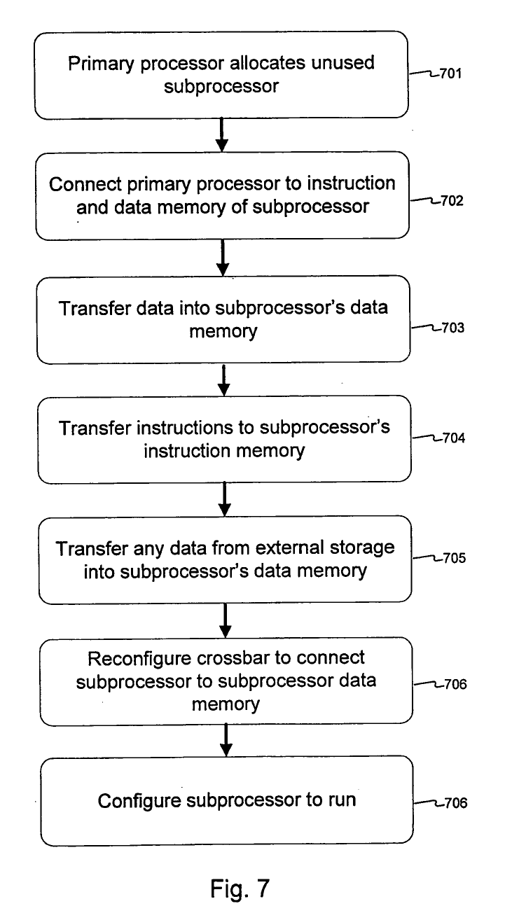

FIG. 7 depicts a flow chart of one preferred sequence of operation for a subprocessor according to one embodiment of the present invention. In the preferred first step 701 to configure a sub-processor 100 the primary processor 15 allocates one of the unused subprocessors 100 from the pool of subprocessors. The status of the pool of processors is tracked by the sub-processor status register in the primary processor register set. To configure the designated sub-processor 100 the primary processor 15 writes to the sub processor control register 48 setting up the appropriate crossbar 99 port such that the instruction memory 131 and the data memory 170 in the sub-processor are connected to the datapath of the primary processor 15 (step 702).

In step 703, preferably primary processor 15 next reads the first line of data to be processed from it location and writes that into the subprocessors data memory. Primary processor 15 then reads the subsequent line of data and loads it into the subprocessors data memory until the entire block of data to be processed is loaded into the data memory.

In a preferred sequence of operation, with a direct link to the target sub-processor 100's instruction memory established, primary processor 15 now has read write access into the instruction memory 131 of the sub-processor (step 704). Primary processor 15 then performs a read from the location in external storage that contains the first line of code that sub-processor 100 will execute and writes it into the first instruction memory location. Primary processor 15 then performs a read from the next location in external storage that contains the next line of code that the sub-processor 100 will execute and writes it into the next instruction memory location. This continues until the entire routine that the sub processor will execute has been loaded into the instruction memory 131.

The crossbar 99 may be configured such that one or more of the instruction memories are being written to at the same time.

In step 705 of this embodiment, after the program code sequence has been loaded into the instruction memory the primary processor then retrieves the data to be processed from external storage and writes the data into the sub-processor's data memory 170. Primary processor 15 then performs a read from the location in external storage that contains the first block of data that the sub-processor will process and writes it into the first data memory location. Primary processor 15 then performs a read from the next location in external storage that contains the next block of data to be processed and writes it into the next data memory location. This continues until the entire block of data that the sub processor 100 will operate on has been loaded into the data memory.

Crossbar 99 may be configured such that one or more of the data memories are being written to at the same time. Other sequences may be used for configuration. For example, instruction memory 131 may first be loaded, and then data memory 170. Further, other connection schemes may be used. For example, while the preferred embodiment has data busses 62, 63, and 64 connecting the crossbar buss to the data memory 170 and instruction 131 memory of each sub-processor 100, such connection may also be achieved through one data buss which may be configurable to load data memory or instruction memory. Further, some embodiments of subprocessors 100 may use a shared memory space and may thereby be configured by access to only one memory store for both data and instructions.

In this embodiment, when the sub-processor configuration process is complete the primary processor 15 shall reconfigure Xbar 99 such that the instruction memory 131 is now addressed by the respective sub-processor 100's program counter and the output of instruction memory 131 connects to the instruction decode block. The primary processor shall also reconfigure Xbar 99 such that the respective data memory store 170 is reconnected to sub-processor 100's data path.

In this embodiment, after the configuration is complete and the sub-processor memory elements are returned to the control of the sub-processor 100, primary processor 15 writes to the sub-processor control register to change the state of the sub-processor from reset to run (step 706). Changing the state to run from reset causes the instruction addressed by the default value of the program counter to be read from the instruction memory that in turn initiates execution of the program sequence stored in the instruction memory.

Preferably, when the program sequence stored in the subprocessors instruction memory has finished executing, a register write is performed to the subprocessors control register that sets a flag in primary processor's 15 status register corresponding to the sub-processor. This register write is required to indicate that the execution is complete and the results are available. When sub-processor 100 has completed running the configured code sequence, the sub-processor status field in the corresponding sub-processor status register 207 in the primary processor 15 is changed to run to done. Primary processor 15 detects the change in status either by polling the register periodically or by an interrupt if the interrupt enable bit flag is set for the associated sub-processor 100.

In this embodiment, after determining that the sub-processor has completed its routine the primary processor 15 changes the state of the processor to hold from run by writing to the sub-processor control register 207 associated with the selected sub-processor 100. Primary processor 15 then configures Xbar 99 to have read/write access to the sub-processor 100's data memory 170. The results of the processing of the data block stored in the sub-processor 100's data memory 170 is then read from data memory 170 and may be further processed as determined by the program executing on the primary processor 15. There are other possible sequences by which primary processor 15 may obtain results of routines run by a sub-processor 100. For example, a subprocessor 100 may be configured to another data memory store 170 of another subprocessor 100, to the data memory cache 70 of the primary processor 15.

In this embodiment, after sub-processor 100 has completed execution there are four possible next conditions for the sub-processor: idle, load new data, reconfigure sub-processor, re-assign data memory.

In the idle state the sub processor is powered on and is waiting for a command from the primary processor 15 to start the execution of the program in the instruction memory 131.

In the load new data scenario the instruction sequence in the instruction memory remains the same and then a new block of data is written into data memory 170.

In the reconfigure scenario a new program is loaded into the instruction memory and new data is loaded into the data memory.

In the re-assign scenario the program stored in the instruction memory remains the same and the data loaded in the data memory remains the same and the Xbar 99 is re-configured to connect the recently processed data to another sub-processor unit 100.

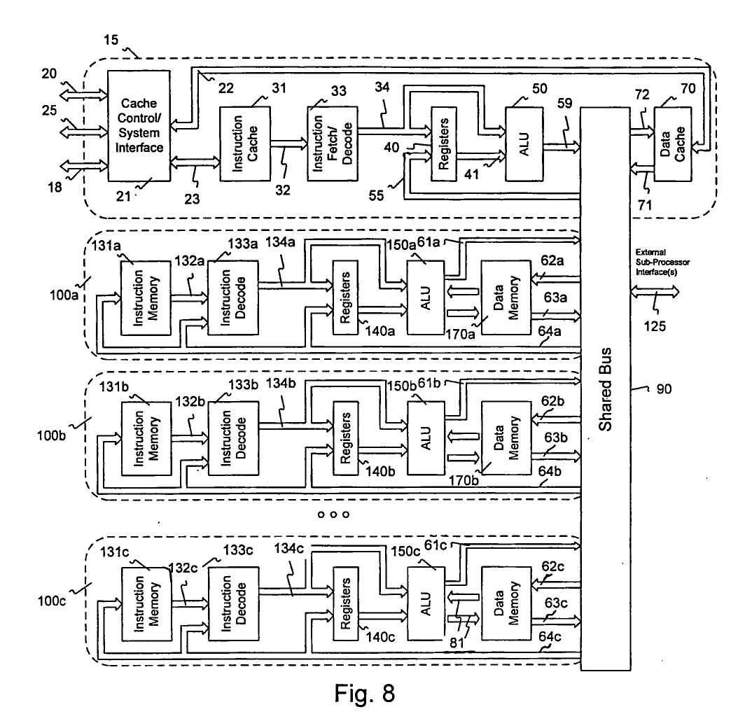

FIG. 8 depicts an alternative embodiment of a processor 1 according to an alternative embodiment of the present invention. A shared buss is used in interconnection network 90 instead of a crossbar buss. In this alternative embodiment, an arithmetic logic unit in each subprocessor has a direct input/output buss 81 to the data memory store 170 for the respective subprocessor. The control input to data memory store 170 may be multiplexed under control of the data memory control registers 208 to allow access by the primary processor through shared buss 90. Such an embodiment may consume less silicon space than a crossbar buss, but may perform more slowly due to increased wait times to access the shared buss.

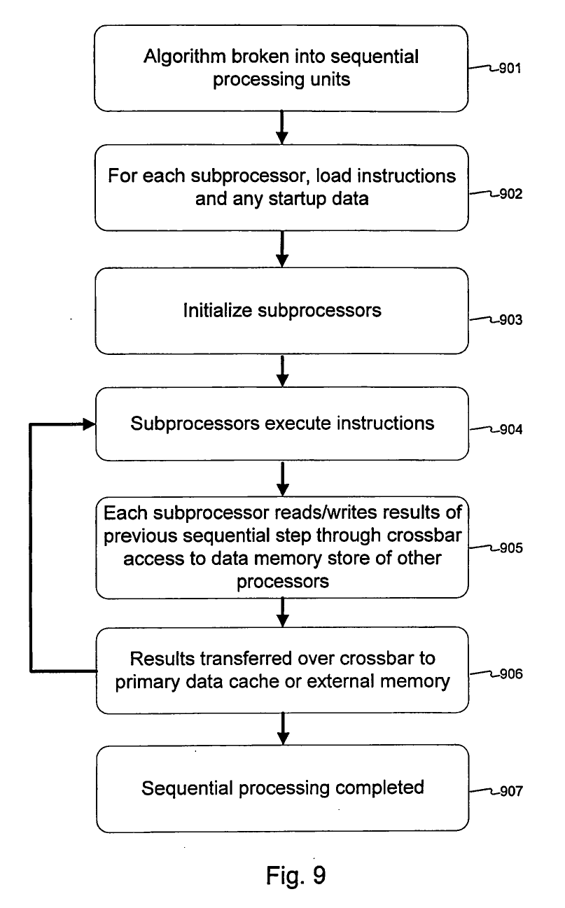

FIG. 9 depicts a sequence of operation according to one embodiment of the present invention. In this embodiment, a processor 1 according to the present invention may be used to process an algorithm sequentially. Some algorithms that may benefit from such a sequential arrangement are signal processing and image processing, protocol stack implementations, and many other algorithms known in the art. To execute such an algorithm sequentially, the algorithm is first divided into sequential pieces in step 901. This may be done during design and compiling of the algorithm, or may be done by primary processor 15. Step 901 produces or identifies sequential pieces of the algorithm for allocation into the various subprocessors.

In step 902 of this embodiment, primary processor 15 loads instructions and data into selected subprocessors 100 to initialize them. Such data may be done for each subprocessor according to the sequence described with reference to FIG. 7. Other initialization sequences may be used. Step 903 sets the subprocessor control and status registers 207 for each processor involved in the sequential processing. This step may involve timing activation of subprocessors to ensure the first sequential pass through the algorithm steps awaits the proper output of the previous steps. Primary processor 15 may conduct such timing management during the entire execution of a particular sequential algorithm.

In step 904 of this embodiment, the various subprocessors execute their respective instructions on data stored in their respective data memories 170. In step 905, each processor writes the results of the algorithm step to a data memory store 170. The results may be written to the data memory store for that particular processor, or may be written to a data memory store for the next particular processor. For example, subprocessor 100a (FIG. 2) may complete a sequential step and write resulting data to data memory 170a or data memory 170b. Each processor may set flags in subprocessor control and status registers 207 to indicate it has completed its sequential piece of the algorithm. Preferably, primary processor 15 configures each subprocessor access to access the data memory store 170 of other processors as needed for the sequential processing of data. For example, if subprocessor 100a writes results of its processing to data memory store 170a, subprocessor 100b may need access to data memory store 170a to acquire data for its own next round of execution when step 904 is encountered again.

Embodiments having a crossbar buss 99 may configure such access for all or most of the needed ports simultaneously through use of a fully connected crossbar buss. Alternatively, crossbar buss 99 may be designed to only provide ports for connections needed in an application for which processor 1 is intended.

In step 906 of this embodiment, primary processor 15 may transfer or allow transfer of output data from the sequential algorithm to data memory cache 70 or external memory 16. Preferably, primary processor 15 tracks the rounds of execution and configures subprocessors 100 to stop execution when data processing is complete. Such tracking may be accomplished, for example, by counting rounds after the final input data has been introduced, by interrupts, and by watching for specified results in the output data of the sequential processing algorithm. An incomplete sequential algorithm proceeds from step 906 back to step 904. A completed algorithm proceeds to step 907, where subprocessors 100 are deactivated or configured for processing other data or execution of other instructions.

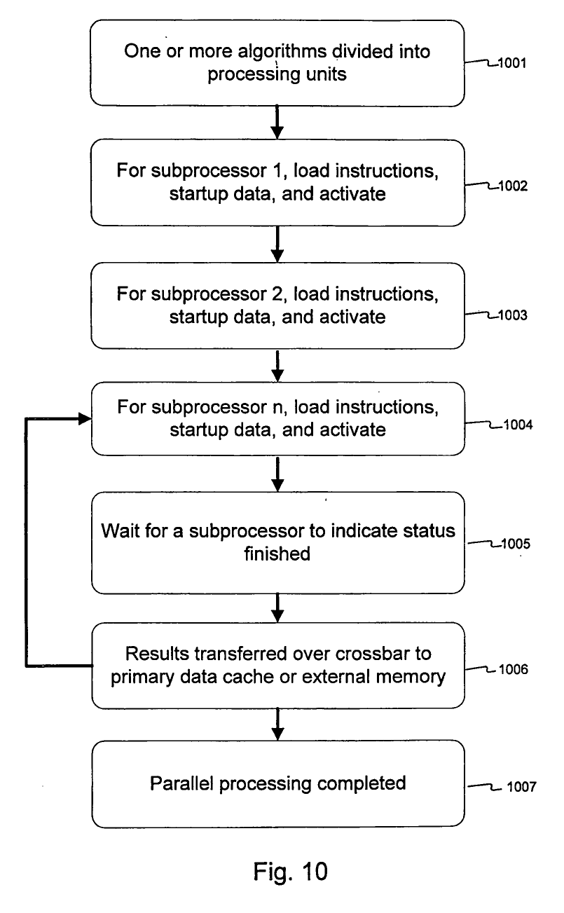

FIG. 10 depicts one alternative sequence of operation according to one embodiment of the present invention. In step 1001 of this embodiment, one or more algorithms are divided into processing units. Ideally, such units are sets of instructions that do not require input from subroutines of other units. Such division is known in the art of parallel processing. Step 1001 may include replication of a particular algorithm and preparation of various data as an input to the multiple instantiations of such algorithm. For example, a cryptanalysis program may wish to check a number of keys or other intermediate data against a set of data under test to see if a certain output results. In this example, step 1001 would prepare the input data for each key under test.

In steps 1002-1004, subprocessors 100 are loaded with instructions and startup data, and then activated. Preferably, if each subprocessor 100 is to run an identical algorithm, crossbar buss 99 connects primary processor 15 to all of the subprocessors to load the instructions into their instruction memory 131 simultaneously. Each subprocessor 100 is loaded with startup data and activated to begin processing as primary processor 15 moves to the next subprocessor 100 in the sequence. An activation step may include more than one subprocessor before moving to the next subprocessor. By such a sequence, primary processor 15 may achieve greater algorithmic efficiency when each iteration of the algorithm in question takes a long time to run.

In step 1005 of this embodiment, primary processor 15 waits for a subprocessor to indicate a finished status. Such indication preferably occurs through subprocessor control and status registers 207. Upon completion of instructions by a subprocessor, primary processor 15 transfers resulting data over crossbar buss 99. If more subroutines or segments need execution, the sequence returns to step 1004 to load and activate the idle processor. A complete sequence proceeds to step 1007.

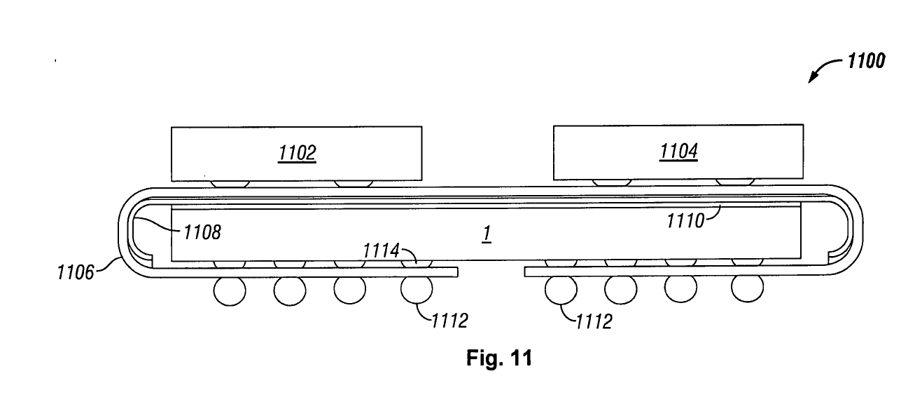

FIG. 11 is an elevation view of an example module 1100 that may be employed in accordance with one preferred embodiment of the present invention. Exemplar module 1100 is comprised of three chipscale packaged integrated circuits (CSPs). The lower depicted CSP is a packaged processor 1 (FIG. 2). The upper CSPs 1102 and 1104 may be external memory CSPs or other supporting components. The three depicted CSPs are connected with flex circuitry 1106, supported by form standard 1108.

Flex circuitry 1106 is shown connecting various constituent CSPs. Any flexible or conformable substrate with an internal layer connectivity capability may be used as a preferable flex circuit in the invention. The entire flex circuit may be flexible or, as those of skill in the art will recognize, a PCB structure made flexible in certain areas to allow conformability around CSPs and rigid in other areas for planarity along CSP surfaces may be employed as an alternative flex circuit in modules 10. For example, structures known as rigid-flex may be employed. Preferably, flex circuitry 1106 is a multi-layer flexible circuit structure having at least two conductive layers, examples of which are described in U.S. application Ser. No. 10/005,581, now U.S. Pat. No. 6,576,992. Other modules may employ flex circuitry that has only a single conductive layer. Preferably, the conductive layers employed in flex circuitry of module 10 are metal such as alloy 110. The use of plural conductive layers provides advantages and the creation of a distributed capacitance across module 1100 intended to reduce noise or bounce effects that can, particularly at higher frequencies, degrade signal integrity, as those of skill in the art will recognize.

Form standard 1108 is shown disposed adjacent to upper surface of processor 1. Preferably, form standard 1108 is devised from copper to create a mandrel that mitigates thermal accumulation while providing a standard-sized form about which flex circuitry is disposed. Form standard 1108 may be fixed to the upper surface of the respective CSP with an adhesive 1110 which preferably is thermally conductive. Form standard 1108 may also, in alternative embodiments, merely lay on the upper surface or be separated by an air gap or medium such as a thermal slug or non-thermal layer. Form standard 1108 may take other shapes. Form standard 1108 also need not be thermally enhancing although such attributes are preferable.

Module 1100 of FIG. 11 has plural module contacts 1112. Shown in FIG. 11 are low profile contacts 1114 along the bottom of processor 1. In some modules 10 employed with the present invention, CSPs that exhibit balls along lower surface are processed to strip the balls from the lower surface or, alternatively, CSPs that do not have ball contacts or other contacts of appreciable height are employed. The ball contacts are then reflowed to create what will be called a consolidated contact. Modules 1100 may also be constructed with normally-sized ball contacts.

Although the present invention has been described in detail, it will be apparent to those skilled in the art that many embodiments taking a variety of specific forms and reflecting changes, substitutions and alterations can be made without departing from the spirit and scope of the invention. The described embodiments illustrate the scope of the claims but do not restrict the scope of the claims.

1. A processing unit comprising:
a primary processor having an arithmetic logic unit, a data memory cache, one or more subprocessor control and status registers; and a crossbar buss associated with the primary processor that interconnects the arithmetic logic unit to the data memory cache, the crossbar buss having a plurality of ports and being capable of providing multiple connection paths between respective selected sets of ports at the same time;
one or more subprocessors interconnected to the crossbar buss, each of the one or more subprocessors having a data memory store and an instruction memory store, the crossbar buss connected to the data memory store and to the instruction memory store.

2. The processing unit of claim 1 further comprising one or more data memory control registers on the primary processor, the data memory control registers operative to configure the crossbar buss to connect the arithmetic logic unit to a selected one or more of a group comprising the data memory cache and the data memory stores of the one or more subprocessors.

3. The processing unit of claim 2 in which the one or more data memory control registers are operative to configure the crossbar buss to connect the arithmetic logic unit to a selected one or more instruction memory stores of the one or more subprocessors.

4. The processing unit of claim 1 in which the one or more subprocessors are re-configurable logic elements.

5. The processing unit of claim 1 in which the crossbar buss has a plurality of data buss ports, there being enough data buss ports to connect to at least one buss for each of the one or more subprocessors.

6. The processing unit of claim 1 in which the crossbar buss has a plurality of data buss ports, there being enough data buss ports to connect to at least one memory buss for each of the one or more subprocessors and at least one instruction memory buss for each of the one or more subprocessors.

7. The processing unit of claim 1 further comprising an address decoder attached to the crossbar buss, the address decoder for generating enable signals for one or more of the subprocessors.

8. The processing unit of claim 1 further comprising an expansion processor buss for connecting to an expansion processor, the expansion processor buss being connected to the crossbar buss.

9. The processing unit of claim 1 further comprising a read data multiplexer on the crossbar buss.

10. A processing unit comprising:
a primary processor having an arithmetic logic unit and data memory cache;
one or more subprocessors;
one or more memory data stores, each of the memory data stores associated with at least one of the one or more subprocessors;
a buss connecting the arithmetic logic unit of the primary processor to the data memory cache of the primary processor and to the one or more memory data stores.

11. The processing unit of claim 10 in which the buss is a crossbar buss.

12. The processing unit of claim 10 in which the buss is a crossbar buss and in which each of the memory data stores is associated with at least one of the one or more subprocessors by having one or more data busses connectible to one or more corresponding data busses on the at least one subprocessor though the crossbar buss.

13. The processing unit of claim 10 in which the primary processor has one or more data memory control registers operative to configure the crossbar buss to connect the arithmetic logic unit to a selected one or more instruction memory stores of the one or more subprocessors.

14. The processing unit of claim 10 in which the primary processor has one or more subprocessor control and status registers operative to configure the one or more subprocessors for operation.

15. The processing unit of claim 11 further comprising a read data multiplexer on the crossbar buss.

16. The processing unit of claim 11 further comprising an address decoder on the crossbar buss, the address decoder for generating enable signals for one or more of the subprocessors.

17. A method of processing an algorithm on a multiple-processor system, the method comprising the steps:
connecting, with a crossbar buss, an arithmetic logic unit on a primary processor to a data cache on the primary processor;
connecting, with the crossbar buss, the arithmetic logic unit on the primary processor to a first data memory store associated with a first subprocessor;
loading data intended to be processed by the first subprocessor into the first data memory store;
connecting, with the crossbar buss, the arithmetic logic unit on the primary processor to a first instruction memory store associated with the first subprocessor;
loading instructions intended to be executed by the first subprocessor into the first instruction memory store;
connecting, with the crossbar buss, the arithmetic logic unit on the primary processor to a second data memory store associated with a second subprocessor;
loading data intended to be processed by the second subprocessor into the second data memory store;
connecting, with the crossbar buss, the arithmetic logic unit on the primary processor to a second instruction memory store associated with the second subprocessor;
loading instructions intended to be executed by the second subprocessor into the second instruction memory store.

18. The method of claim 17 further including the step of setting a subprocessor control and status register to activate the first subprocessor.

19. The method of claim 17 further including the step of waiting for an indication in the subprocessor control and status register that the first subprocessor has completed processing the instructions.

20. The method of claim 17 in which the step of connecting the arithmetic logic unit on the primary processor to the first instruction memory store is done simultaneously with the step of connecting the arithmetic logic unit on the primary processor to the second instruction memory store.

21. The method of claim 17 in which the step of loading instructions intended to be executed by the first subprocessor into the first instruction memory store is done simultaneously with the step of loading instructions intended to be executed by the second subprocessor into the second instruction memory store.

22. The method of claim 17 further including the step of reading, by the second subprocessor, algorithmic output data from first data memory store over the crossbar buss.

23. The method of claim 17 further including the step of writing, by the first subprocessor, algorithmic output data to the second data memory store over the crossbar buss.

24. A circuit module comprising:
a processor packaged in a chipscale package, the processor having an arithmetic logic unit, one or more subprocessors, a data memory cache, one or more data memory stores associated with the one or subprocessors, and a crossbar buss associated with the processor and connecting the arithmetic logic unit to the data memory cache and the data memory stores;
flexible circuitry wrapped about the chipscale package to dispose a first portion of the flexible circuitry above the chipscale package and a second portion of the flexible circuitry below the chipscale package;
one or more semiconductor components mounted to the first portion of the flexible circuitry.

25. The circuit module of claim 24 in which the one or more semiconductor components includes at least one memory component, the memory component configured to function as external memory for the processor.

26. The circuit module of claim 24 further comprising a form standard disposed between the flexible circuitry and the chipscale package.
